(19) United States
(12) Patent Application Publication
(10) Pub. No.: US 2015/0299026 A1
(43) Pub. Date: Oct. 22, 2015

(54) GLASS COMPOSITION FOR THE USE AS A SEALANT

(71) Applicant: DANMARKS TEKNISKE UNIVERSITET, Lyngby (DK)

(72) Inventors: Wolff-Ragnar Kiebach, København (DK); Peter Vang Hendriksen, Hillerød (DK)

(21) Appl. No.: 14/431,058

(22) PCT Filed: Sep. 27, 2013
(86) PCT No.: PCT/EP2013/070182

§ 371 Date: Mar. 25, 2015

(30) Foreign Application Priority Data
Sep. 28, 2012 (EP) 12006777.2

(51) Int. Cl. C03C 3/066; H01M 8/10; C25B 9/00; H01M 8/02

(52) U.S. Cl. CPC C03C 3/066; H01M 8/0282; H01M 8/1004; C25B 9/00; H01M 2300/0071

(57) ABSTRACT

The invention concerns a glass composition for the use as a sealant, particularly in a solid oxide fuel cell (SOFC) or in a solid oxide electrolyser cell (SOEC). The glass composition comprises 5-70 mol % CaO, 5-45 mol % ZnO, 5-50 mol % B₂O₃, 1-45 mol % SiO₂, and 1 mol % or less of each element of the group, comprising Ba, Na and Sr, based on the total glass composition. Furthermore, the invention relates to an SOFC and an SOEC employing a sealant of said glass composition.

The present invention relates to a glass composition for the use as a sealant, particularly in a solid oxide fuel cell (SOFC) or in a solid oxide electrolyser cell (SOEC). Furthermore, the present invention relates to an SOFC and an SOEC employing a sealant comprising said glass composition.

### BACKGROUND

SOFCs are electrochemical devices converting chemical energy of a fuel into electricity. SOECs are operated in the reversed way, i.e. convert electricity into chemical energy. These devices have working temperatures of approximately 700° C. to 1000° C., while current research is done to develop materials and fabrication processes that permit an operation at temperatures of 600° C. or lower. Conventionally known devises include a plurality of SOFC/SOEC cells, each comprising an anode and cathode layer and an ion conducting electrolyte interposed between these layers. These cells are typically arranged in series of stacks. The SOFC/SOEC devices must ensure the separation of the fuel and reaction gases, which is commonly achieved by sealing the cells with a sealant. This sealant must exhibit a high adhesion to the sealed parts of the fuel cell. Furthermore, the sealant should show a coefficient of thermal expansion (CTE) that fits with the other full cell components in order to avoid cracking.

Commonly known sealing materials constitute glass or glass ceramic materials that contain SiO₂ as major component. For example, US 2010/0233567 A1 discloses a solid oxide fuel cell stack obtainable by a process comprising the use of a glass sealant, wherein the sealant has the following composition: 50-70 wt % SiO₂, 0-20 wt % Al₂O₃, 10-50 wt % CaO, 0-10 wt % MgO, 0-6 wt % (Na₂O+K₂O), 0-10 wt % B₂O₃, and 0-5 wt % of functional elements selected from TiO₂, ZrO₂, F, P₂O₅, MoO₃, Fe₂O₃, MnO₂, La_Sr—Mn—O perovskite (LSM) and combinations thereof. These known sealants show a relatively high amount of SiO₂, which may lead to a high Si emission during operation that is associated with a potential degradation, which may lead to a insufficient life time of the cell.

Glass compositions with lower SiO₂ contents are shown in JP 2007-161569, which discloses a powdery composition that is useful for forming a crystallized glass for sealing a SOFC, and which contains 10-30 mass % SiO₂, 20-30 mass % B₂O₃, 10-40 mass % CaO, 15-40 mass % MgO, 0-10 mass % of BaO+SrO+ZnO, 0-5 mass % La₂O₃, 0-5 mass % Al₂O₃, and 0-3 mass % RO₂ (wherein, R represents Zr, Ti or Sn). However, this glass composition employs a high amount of MgO in combination with a low amount of ZnO. In view of this, the glass composition may not show a sufficiently low glass transition temperature in order to especially fit with the recently developed SOFCs and SOECs that are operated at low working temperatures.

Barium, as employed in the prior art cited above, is also used in U.S. Pat. No. 6,430,966, which employs Ba containing glasses in order to achieve a sufficiently high CTE. However, Ba will form BaCrO₄, when used in contact with steel materials, which is associated with disadvantageous effects such as discussed e.g. in: Zhenguo Yang, Jeff W. Stevenson, Kerry D. Meinhardt, Chemical interactions of barium-calcium-aluminosilicate-based sealing glasses with oxidation resistant alloys, Solid State Ionics 160 (2003) 213-225.

Moreover, US 2008/0142148 discloses a method of manufacturing metal to glass, metal to metal and metal to ceramic connections to be used in SOFC applications, said connections being produced as a mixture of a base glass powder and a metal oxide powder. As a result, the inherent properties of the glass used in the composite seals may be altered locally in the metal-coating interface by adding e.g. MgO in order to control the viscosity and wetting, and at the same time maintain the bulk properties such as high coefficient of thermal expansion of the basic glass towards the seal components.

These commonly known materials are still improvable with regard to their adhesion to the sealed substrate, CTE, life time, durability and mechanical stability. Furthermore, there is still a need for glass compositions that act as sealants, particularly for SOFC/SOEC, which allow a reliable and cost effective preparation and which are compatible with existing manufacturing techniques.

### OBJECT OF THE PRESENT INVENTION

The object of the present invention is the provision of a glass composition that is suitable for the use as a sealant, which meets at least one of the following properties: it can be produced in a reliable and cost efficient manner, it is compatible with existing manufacturing techniques, it shows high adhesion to the sealed substrate, it shows a thermal coefficient of expansion that fits with the other components of the sealed device, and it shows a sufficient life time, durability, chemical stability and mechanical stability. Further objects will become apparent from the following description.

### SUMMARY

This object is achieved by a glass composition in accordance with claim 1. Preferred embodiments of the glass composition are specified in claims 2 to 12. The present invention also encompasses a solid oxide fuel cell in accordance with claim 13, a solid oxide electrolyser cell in accordance with claim 14 and a use in accordance with claim 15. The invention covers any preferred embodiments specified in the claims and in the following description singly or in any combination.

### DETAILED DESCRIPTION

The glass composition in accordance with the present invention comprises 35-70 mol % CaO, 5-45 mol % ZnO, 5-50 mol % B₂O₃, and 1-45 mol % SiO₂. Any ranges for the glass composition given in the present invention are based on the total glass composition. In the following, the components of the glass specification, preferred embodiments and their effects are explained in more detail. All these embodiments are presented within the context of the present invention, i.e. all these embodiments may be combined as they describe aspects of the present invention.

### CaO:

The content of CaO in the glass composition is 35-70 mol %. In embodiments, the glass composition comprises CaO in 35-60 mol %, preferably 35-55 mol %, and more preferably 45-50 mol %. More specifically, CaO preferably is the major component of the glass composition, i.e. may be present in 50 mol % or more. The amount of CaO ensures a coefficient of thermal expansion (CTE) that matches with the other components of the sealed substrate. With regard to SOFC/SOEC substrates, such a range ensures that the CTE of the sealant between room temperature and the operating temperature of the fuel cell is approximately the same to the other components of the cell, which in turn avoids cracking and leakage. If the content of the CaO is outside of this range, the differences of the CTE would be too high so that the life time of the cell would be reduced. Furthermore, this range facilitates melting and refining, especially when compared to SiO₂ dominated glass compositions. This in turn enables the production of a sealant that can be particularly employed in SOFC/SOEC, which can be sealed at low temperatures of e.g. 650-800° C. or lower.

### ZnO:

The glass composition comprises 5-45 mol % ZnO. In embodiments, the ZnO content is 10-35 mol %, preferably 12.5-30 mol % and more preferably 17.5-25 mol %. ZnO acts as a nucleating agent in the inventive glass composition. The presence of ZnO is this range ensures a sufficiently high and fast nucleation, which, on the other hand, leads to small crystallite sizes and a fine microstructure. ZnO also imparts a high stability against deformation under stress resulting in improved mechanical properties. The presence of ZnO in the composition in accordance with the present invention furthermore enables, when the composition in accordance with the present invention is used in contact with a steel surface, the formation of a thin layer of ZnO near the interface with the steel surface, which protects the metal from corrosion or reaction with other components of the composition. This is an additional benefit of the composition in accordance with the present invention.

### B₂O₃:

The glass composition also comprises 5-50 mol % B₂O₃. In embodiments, the glass composition can comprise 10-45 mol %, preferably 15-30 mol % and more preferably 17.5-25 mol % B₂O₃. B₂O₃ acts as a glass former, i.e. decreases the viscosity and amount of crystallization of the glass composition. This content of B₂O₃ ensures a sufficiently low viscosity at the desired sealing temperature.

### SiO₂:

The glass composition further comprises 1-45 mol % SiO₂. In embodiments, the glass composition comprises 2.5-35 mol %, preferably 5-25 mol % and more preferably 7.5-15 mol % SiO₂. This range ensures a sufficient glass forming capability of the composition, while keeping the SiO₂ content relatively low. The low SiO₂ content minimizes undesired Si emissions in the SOEC mode, i.e. ensures a low degradation of the glass composition and enables a long life time. The reduced SiO₂ content is also advantageous in the SOFC mode due to the fact that Si is considered to increase the resistance, i.e. to decrease the performance, and to lower the lifetime of SOFC stacks. In this context, reference is made to Horita T, Kishimoto H, Yamaji K, Brito M E, Xiong Y P, Yokokawa H, Hori Y and Miyachi I. “Effects of impurities on the degradation and long-term stability for solid oxide fuel cells.” Journal of Power Sources. 2009; 193(1):194-198.

### Elements Ba, Na and Sr:

The glass composition is also substantially free of any of the elements Ba, Na and Sr, which means that each element of the group comprising Ba, Na and Sr is present in the composition in an amount of 1 mol % or less. Preferably, the composition also comprises any other alkali elements in an amount of 1 mol % or less. In further preferred embodiments, the content of any of these elements is 10 mmol % or less, more preferably 0.1 mmol % or less. This low Ba, Na and Sr content and optionally low content of other alkali metals suppresses the formation of chromates which would lead to failure of the sealant due to brittleness and thermal mismatch during operation (if in contact with a Cr containing surface, such as a steel support). In view of this, the life time, mechanical stability and durability of the sealant can be enhanced.

### Other Components:

In embodiments, the glass composition comprises no MnO, Since MnO acts as a crystallization agent in a glass composition, in embodiments, however, the content of MnO is 5 mol % or less, preferably 2.5 mol % and more preferably 1 mol % or less. A low content of MnO as identified above enables a sufficiently low viscosity and low amount of crystallization of the glass composition.

The glass composition also may contain one or more compounds of the group comprising La₂O₃, Y₂O₃, PbO, Cr₂O₃, V₂O₅, NiO, CuO, TiO₂, ZrO₂, As₂O₃, Sb₂O₃, Al₂O₃ and Fe₂O₃. These compounds may be used as additives to adjust the properties of glass composition, such as the coefficient of thermal expansion, the melting temperature, the glass transition temperature, the softening temperature, the viscosity, the elastic modulus, the surface tension, the adhesion, the crystallization behaviour, the corrosion resistance and the diffusion properties of the glass composition. The effects of these elements in glass compositions are known in the prior art and will not be explained in detail. The inventive glass composition may contain these additives in usual amounts, such as in e.g. up to 5 mol %. However, a preferred embodiment of the glass composition does not comprise any of these compounds, which means in embodiments that the content of the sum of these components is 5 mol % or less, preferably 2.5 mol % and more preferably 1 mol % or less.

### Preferred Embodiments

A preferred glass composition comprises 35-60 mol % CaO, 10-35 mol % ZnO, 10-40 mol % B₂O₃ and 2.5-35 mol % SiO₂. A more preferred glass composition comprises 35-50 mol % CaO, 12.5-30 mol % ZnO, 15-30 mol % B₂O₃ and 5-25 mol % SiO₂. A particularly preferred glass composition comprises 45-55 mol % CaO, 17.5-25 mol % ZnO, 17.5-25 mol % B₂O₃ and 7.5-15 mol % SiO₂. Most preferably, the glass composition comprises 50 mol % CaO, 20 mol % ZnO, 20 mol % B₂O₃ and 10 mol % SiO₂. These compositions particularly ensure a high adhesion to the sealed substrate and a thermal coefficient of expansion that fits with the other components of the sealed device, a sufficient life time, a high durability and a high chemical and mechanical stability.

In a further preferred aspect of the present invention, the glass composition consists of the components CaO, ZnO, B₂O₃ and SiO₂, which may be present in any combination of the ranges as defined herein. The term “consists of” means that the glass composition is substantially free of other components than CaO, ZnO, B₂O₃ and SiO₂. The term “substantially free” means in embodiments that the sum of any other components in the glass composition is 3 mol % or less, preferably 1 mol % or less, more preferably 10 mmol % or less, most preferably 0.1 mmol % or less.

In a further preferred embodiment, the sum of CaO, ZnO and B₂O₃ is 60 mol % or more, preferably 70 mol % or more and more preferably 80 mol % or more. This embodiment facilitates a particularly high adhesion, high CTE, excellent life time and high durability.

### Physical Properties and Microstructure:

The glass composition can show in embodiments a coefficient of thermal expansion (CTE) of 6 to 16×10⁻⁶/° C., preferably 8 to 14×10⁻⁶/° C., and more preferably 11 to 13×10⁻⁶/° C. This CTE is in the range of the CTE of the other parts of a SOFC/SOEC stack so that a CTE in said range fits with the CTE of other stack components, which in turn avoids any cracking and leakage. The CTE is obtained by dilatometry measurement.

The glass composition may show in embodiments a melting temperature Tₘ of 1200° C. or less, preferably 1100° C. or less, more preferably 1000° C. or less. In further preferred embodiments, the glass transition temperature T_{g} of the glass composition is 1000° C. or less, preferably 800° C. or less, more preferably 600° C. or less. The glass transition temperature and the melting temperature correspond to the onset temperatures as determined by differential scanning calorimetry (DSC, in Ar; heating range 10° C./min).

This low melting temperature and/or glass transition temperature facilitates that the sealant shows the ability of self-healing, which is a further advantageous aspect of the inventive glass composition. The term “self-healing” is defined as the possibility to cure or close cracks or other leaks in the sealing structure during operation. This effect can be achieved, when the operating temperature of the sealed device is higher than the melting temperature of the sealant. In this case, the glass composition at least partially (re)melts and, thus, can refill any cracks and gaps that may have occurred in the sealing structure. Since the present glass composition shows a favourably low Tₘ, the glass composition in accordance with the present invention can exhibit a high self-healing ability due to the increased fluidity that closes leaks or gaps.

In a further preferred embodiment, the glass composition shows a predominantly crystalline structure, which preferably means that the glass composition comprises crystalline areas in 50% or more, more preferably in 60% or more, most preferably 75% or more. The amount of crystalline areas is determined vie scanning electron microscopy (SEM) by visual inspection. Such a high content of crystallinity is achieved by the specific chemical constitution of the glass composition and/or by appropriately adjusting the sealing process

The glass composition preferably has a semicrystalline structure comprising crystalline areas in an amorphous matrix, i.e. the glass ceramic. The crystallization process is fast (i.e. preferably within 10 hours, more preferably within 5 hours, most preferably within 1 hour) and the final stable structure is reached already after the sealing process. This fast crystallization yields a fine microstructure with a high mechanical stability and durability, whereas slow crystallization and ageing will not change the microstructure significantly over time. However, the glass composition may be in embodiments completely amorphous.

The crystalline areas in the glass composition may be formed by one single crystalline phase. However, the present invention preferably encompasses glass compositions with more than one crystalline phase, such as two or more than two crystalline phases. This ensures a particularly high mechanical stability and durability, while remaining a favorable high CTE.

In particular, the glass composition of the present invention comprises in preferred embodiments a Ca₂ZnSi₂O₇ (hardystonite) crystal phase. The occurrence of this crystal phase is determined by X-ray diffraction analysis (XRD). The formation of Ca₂ZnSi₂O₇ (hardystonite) crystals particularly ensures a high CTE in combination with a high mechanical and chemical stability and durability but also ensures a low brittleness.

In a further preferred embodiment, the glass composition shows in the crystalline parts a crystalline microstructure, wherein the average diameter of crystalline domains (i.e. the crystal phases) is 2000 nm or less, preferably 1000 nm or less, more preferably 500 nm or less. The average diameter is visually detected by measuring the average diameter of crystalline domains in a SEM picture. This low average diameter of crystalline domains constitutes a further favorable aspect of the present invention that is caused by the fast crystallization behaviour of the composition of the glass composition. This specific microstructure of the glass composition leads to a good mechanical and chemical stability over long periods of time.

The novel composition of the glass in accordance with the present invention, in particular, the typically rather high calcium oxide content and the rather lower content of silicon oxide enables these favourable properties.

The glass composition shows a high gas barrier property, i.e. can act as a sealant for gases such as H₂, CO, CO₂, H₂O, alcohols or hydrocarbons. Due to these gas barrier properties, the glass composition in accordance with the present invention is in particular, suitable for the uses as outlined herein, in particular, as sealant for solid oxide fuel cells and solid oxide electrolyser cells. However, the glass composition in accordance with the present invention, due to these carrier properties, may also be employed in other areas requiring gas barrier applications, like membranes sensors or combustion chambers.

### Preparation and Application:

Suitable methods for producing the glass composition in accordance with the present invention are commonly known. In particular, the glass composition may be prepared by mixing the oxides of the components and/or any suitable precursor substances of the components, heating to a temperature of higher than the melting temperature and cooling the mixture by quenching with water. This results in an amorphous starting glass, which may be subsequently pulverized by a milling process to obtain a pulverized glass composition.

The glass composition can be applied on various substrates, such as metal, ceramic, etc. The type of substrate is not limited. In particular, the coating shows a high adhesion to metals and ceramics. The glass composition can be particularly applied to the desired surfaces in a conventional manner in which also conventional glass sealant compositions are applied. Typical examples are screen printing, tape casting and other processes known to the skilled person.

### Uses:

As outlined herein, a glass composition, comprising:
5-70 mol % CaO,
5-45 mol % ZnO,
5-50 mol % B₂O₃,
1-45 mol % SiO₂,
1 mol % or less of each element of the group, comprising Ba, Na and Sr,
   based on the total glass composition may be used as sealant, i.e. in all applications where in particular, a gas-tight seal is required for example, in solid oxide fuel cell and solid oxide electrolyser cell applications. However, due to the fact that the glass composition shows high adhesion to metals and ceramic materials, the glass composition may also be used in order to improve adhesion between a ceramic part and a ceramic, metallic part and a metallic or a ceramic part and a metallic part, i.e. as glass adhesive. Also, in this type of use, it is one of the benefits of the glass composition, that it can be tailored with respect to its thermal properties that, it matches in particular, the coefficient of thermal expansion of parts of various materials to be adhered to each other. Thereby, a safe and failure-free adhesion can be provided.

One of the important fields of application of the glass composition in accordance with the present invention however is the use of a glass composition, comprising:
5-70 mol % CaO,
5-45 mol % ZnO,
5-50 mol % B2O3,
1-45 mol % SiO2,
1 mol % or less of each element of the group, comprising Ba, Na and Sr,
   based on the total glass composition, as sealant in solid oxide fuel cell solid oxide electrolyser cell applications.

The present invention therefore concerns a solid oxide fuel cell (SOFC) and a solid oxide electrolyser cell (SOEC) comprising a glass composition, said glass composition comprising:
5-70 mol % CaO,
5-45 mol % ZnO,
5-50 mol % B₂O₃,
1-45 mol % SiO₂,
1 mol % or less of each element of the group, comprising Ba, Na and Sr,
   based on the total glass composition as a sealant. The SOFC/SOEC comprises an anode layer and a cathode layer and an ion conducting electrolyte interposed between these layers, which are sealed by a sealant comprising the inventive glass composition. The SOFC/SOEC to be sealed by the glass composition is not limited. The SOFC/SOEC includes commonly known set-ups comprising e.g. a porous strontium-doped lanthanum manganite (LSM) electrode, a dense yttria-stabilized zirconia (YSZ) electrode and a porous nickel-zirconium cermet (NZC) fuel electrode. These cells may be arranged in series of stacks, i.e. the SOFC/SOEC comprises a plurality of planar conductive sheets of thin layers of an anode and cathode and a layer of a ceramic ion conducting electrode disposed between the anode and the cathode, which is arranged as a stack. The operating temperature of the SOFC/SOEC is usually in the range of 700° C. to 1000° C. and in embodiments 650° C. or lower, preferably 600° C. or lower.

The SOFC operates by electrochemically reacting fuel gas with an oxidant gas to produce DC output voltage. The SOEC acts in a reverse way by electrochemically generating a fuel gas under a DC input voltage by consumption of a gas such as CO, CO₂ or H₂O or a combination thereof. Suitable fuel gases constitute CO, H₂O or mixtures thereof.

A sealant comprising a glass composition, said glass composition comprising:
5-70 mol % CaO,
5-45 mol % ZnO,
5-50 mol % B₂O₃,
1-45 mol % SiO₂,
1 mol % or less of each element of the group, comprising Ba, Na and Sr,
   based on the total glass composition is suitable to seal any area of a SOFC/SOEC cell or stack, i.e. the place/area and type of substrate is not specifically limited. The sealing in particular ensures the separation of the fuel and the (oxidant) gas. Sealed areas are in preferably the edges of the cells or stacks, which is particularly suitable for the case of planar cell designs that are arranged in a stack. The glass composition is also suitable for sealing further parts of the SOEC/SOFC, such as adjacent sheets. Furthermore, the sealant is suitable for sealing the external manifolds of the stack or for sealing the gas flow channels in an internally manifold of a SOFC/SOEC stack. However, the sealant in accordance with the present invention may also be used at other areas in the fuel cell that are operated at a high temperature.

The glass composition may be applied as a sealant to the SOFC/SOEC substrate according to existing techniques, such as tape casting or screen printing. The glass composition can be prepared by known methods. Reference in this context is made to US 2012/0193223 A1 and to U.S. Pat. No. 8,163,436, which are incorporated herewith by reference. In particular, the solid, amorphous starting glass composition may be heated to a temperature, which is above the glass transition temperature (Tg) in order to obtain a viscous fluid that can be used to seal the substrate. The heating to a temperature of above Tg also may induce the formation of one or more crystalline phases in the composition. Therefore, the sealed glass composition may constitute a semi-crystalline glass ceramic

The use of a glass composition, comprising:
5-70 mol % CaO,
5-45 mol % ZnO,
5-50 mol % B₂O₃,
1-45 mol % SiO₂,
1 mol % or less of each element of the group, comprising Ba, Na and Sr,
   based on the total glass composition, is herewith described as a sealant for sealing various parts of a SOFC or SOEC device. However, a person skilled in the art is aware of the fact that the glass composition is not limited to act as a sealant for SOFC/SOEC. Further devices to be sealed with such a glass composition are e.g. oxygen membranes or sensors.

Preferred and most preferred glass compositions for use as a sealant for SOFC/SOEC's are given above.

The invention is further illustrated by the following examples and with reference to the following figures:

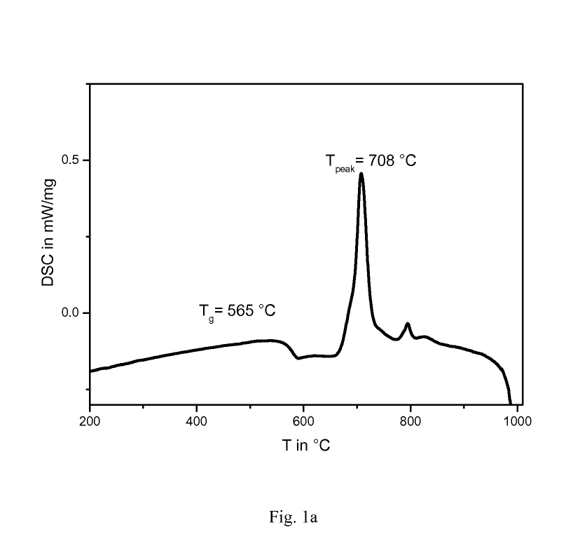

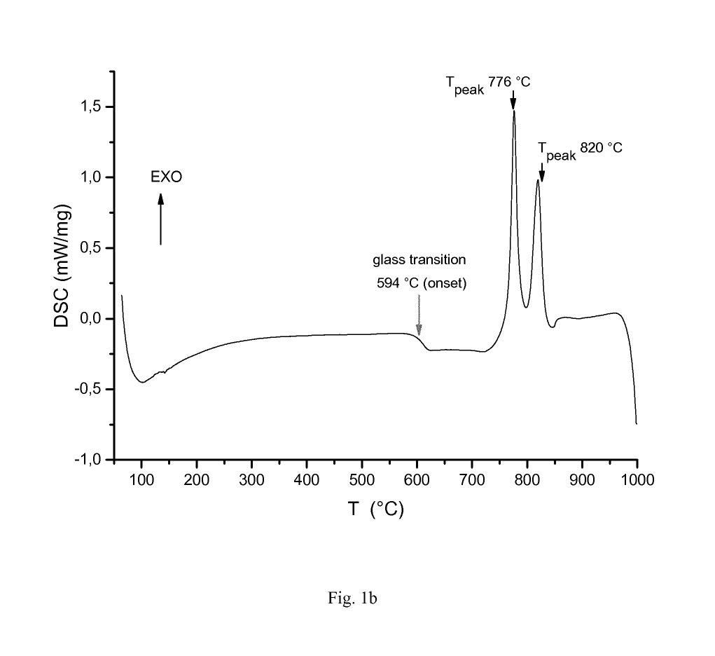

FIG. 1a: DSC measurement of Glass 1

FIG. 1b: DSC measurement of Glass 2

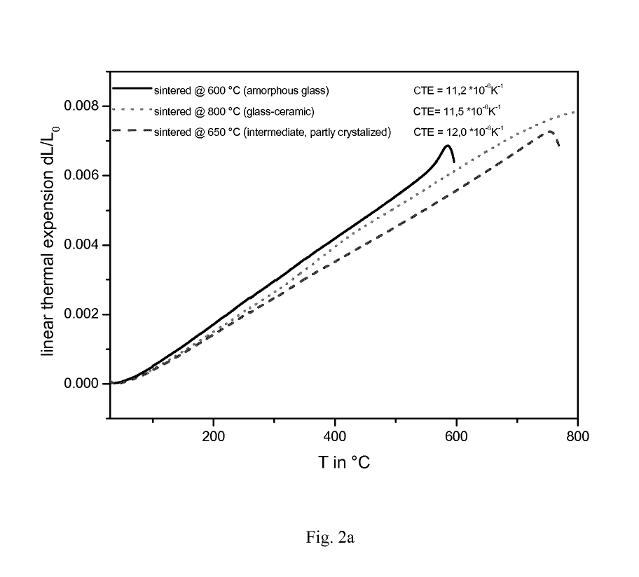

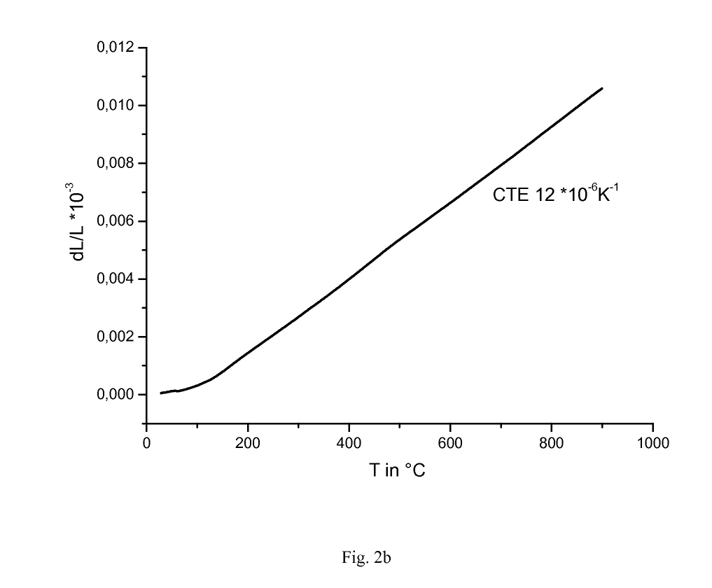

FIG. 2a: Linear thermal expansion curve obtained by dilatometry measurement of Glass 1

FIG. 2b: Linear thermal expansion curve obtained by dilatometry measurement of Glass 2

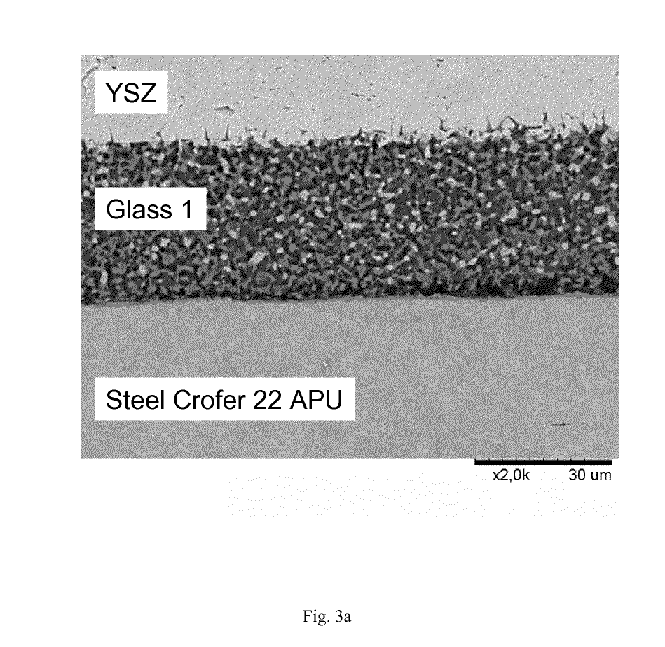

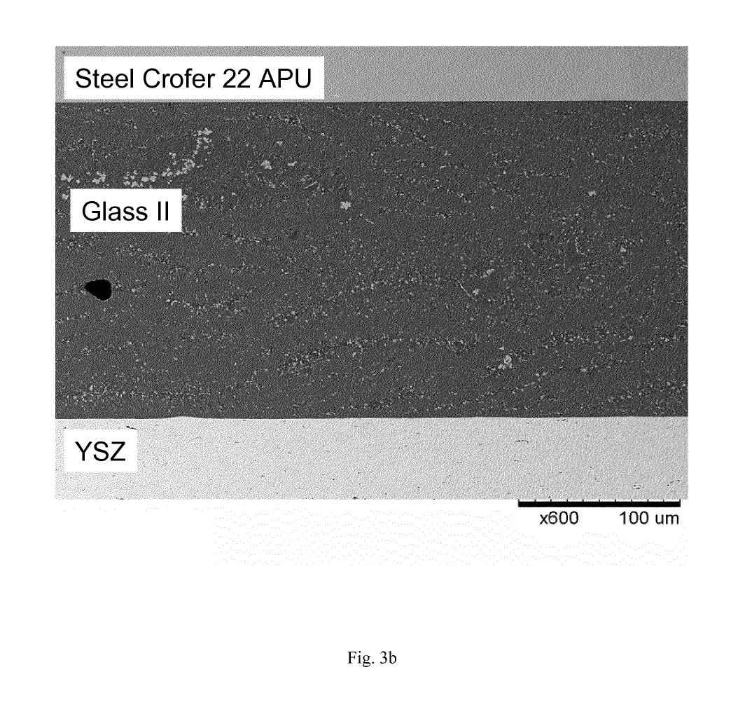

FIG. 3a: SEM micrograph of Crofer 22 APU steel sealed to YSZ using Glass 1

FIG. 3b: SEM micrograph of Crofer 22 APU steel sealed to YSZ using Glass 2

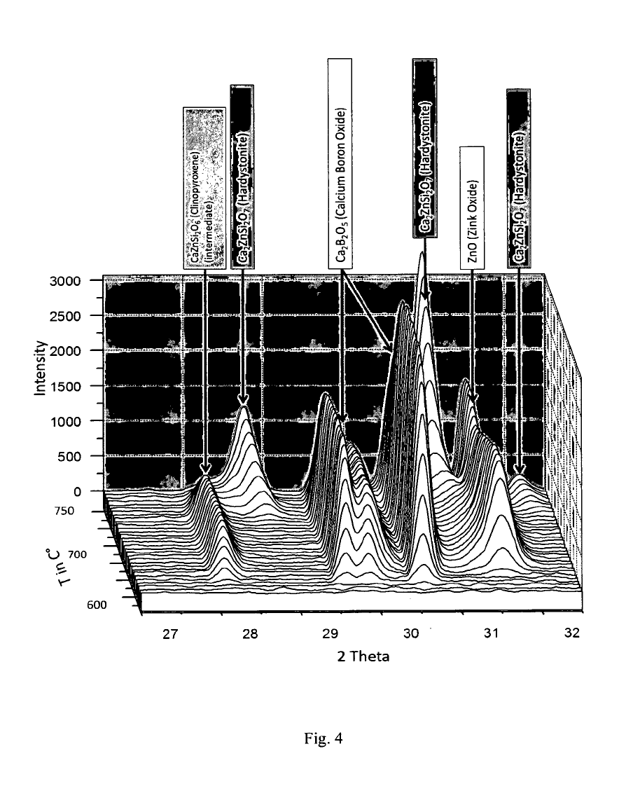

FIG. 4: Temperature resolved XRD spectrum of Glass 2

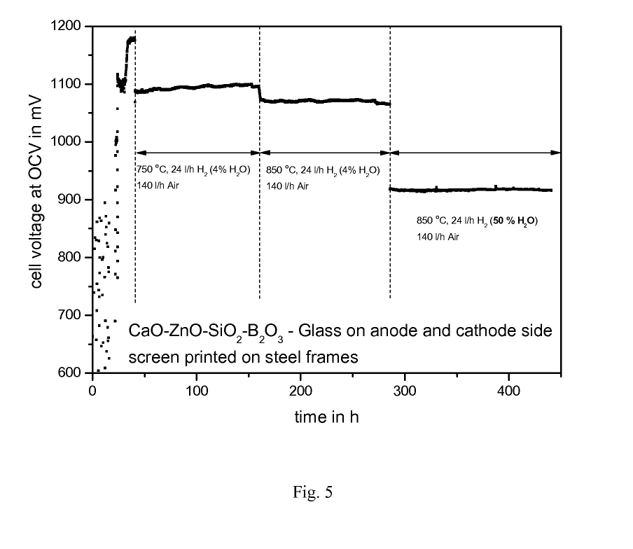

FIG. 5: SOFC/SOEC cell test with Glass 1

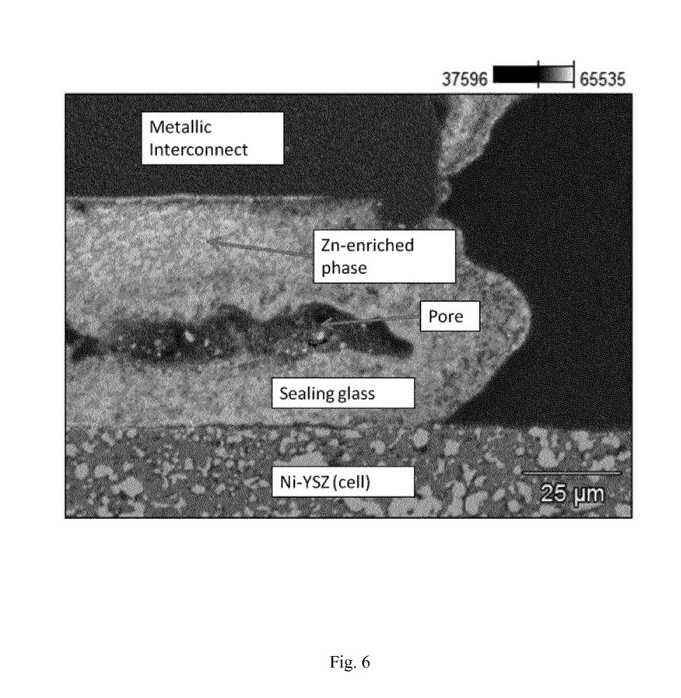

FIG. 6: EDX measurement of SOFC/SOEC cell after cell test

### EXAMPLES

### 1. Preparation of Glass Compositions

Two glass compositions in accordance with the present invention are prepared. Glass composition 1 (Glass 1) is prepared by mixing 48 mol % CaO, 19 mol % ZnO, 21 mol % B₂O₃ and 12 mol % SiO₂. Glass composition 2 (Glass 2) is prepared by mixing 50 mol % CaO, 20 mol % ZnO, 20 mol % B₂O₃ and 10 mol % SiO₂.

The glass compositions are synthesized in the following manner: All reactants are mixed and transferred to a Pt crucible. The mixture is heated up to 1200° C. with a heating rate of 200° C./h and kept at this temperature for 2 hours. Thereafter, the liquid glass melt is quenched by pouring the melt into water in order to obtain an amorphous starting glass. The chemical composition of the starting glass is identical to the mixture of the reactants. Subsequently, the glass composition is produced by milling the start glass in a ball-mill to obtain a powder with a particle size d₅₀ of less than 22 μm.

### 2. Characterization of the Glass Compositions

The thermal behaviour of the glass composition is evaluated by DSC measurement in a temperature range from 30 to 1050° C. in a Pt crucible, by employing 50 mg of the glass. The measurement is performed under argon (flow rate 40 ml/min) with a heating rate of 10° C./min. FIGS. 1a and 1b show DSC curves of Glass 1 and Glass 2, respectively, revealing glass transition temperatures of 565° C./594° C. (Tg onset). Crystallization of Glass 1 and Glass 2 starts at 660° C. and 700° C., respectively. Glass 1 and Glass 2 show melting points (Tm onset) of approximately 990° C.

The coefficient of thermal expansion (CTE) is obtained by dilatometry measurement, which is performed on sintered glass bars in argon (flow rate 50 ml/min) with a heating rate of 3° C./min in a temperature range from 25° C. FIG. 2a shows dilatometry measurement results of three samples of Glass 1 (amorphous state, glass ceramic state and partly crystallized state) and reveals CTE values of 11.2*10⁻⁶K⁻¹, 11.5*10⁻⁶K⁻¹ and 12.0*10⁻⁶K⁻ⁱ, respectively. FIG. 2b shows a dilatometry measurement result of a sample of Glass 2 (glass ceramic state) and reveals a CTE value of 12.0*10⁻⁶K⁻¹.

The adhesion behaviour of Glass 1 and Glass 2 on steel is measured by the following method: The glass composition is applied in the form of powder. YSZ (Y₂O₃—ZrO₂) with 8 mol % Y₂O₃ is produced by tape casting and sintering. The YSZ electrolyte has a thickness of 200 μm after sintering. Crofer22APU (W.-Nr. 1.4760, ThysenKrupp VDM, Werdohl, Germany) with a thickness of 230 μm is used as ferritic steel. All materials are cut into 2 cm×2 cm pieces and joining is conducted by placing the glass powder of Glass 1 and Glass 2, respectively, between the YSZ and the steel. To ensure contact during sealing a load of 4 kg is applied. The assemblies are heated in air with 100° C./h to the final sealing temperature of 800° C. (Glass 2) and 925° C. (Glass 1), respectively. After being held for 20 min at these temperatures, the samples are cooled down at a cooling rate of 100° C./h to room temperature.

These samples were analyzed by SEM/EDX in the following manner: The samples including the glass sealing are vacuum embedded in Struers epoxy resin (epofix), ground using SiC paper, polished using 6.3 μm and 1 μm diamond paste, and are then carbon coated to eliminate surface charging. Images are taken on a Zeiss Supra 35 scanning electron microscope (SEM) equipped with a field emission gun and an EDS detector in backscattered mode with an acceleration voltage of 15 kV.

FIGS. 3a and 3b show SEM micrographs of the samples employing Glass 1 and Glass 2, respectively. These micrographs illustrate that the glass compositions shows good adhesion and wetting the surface due to the fact that no cracks, voids or delamination is found.

The crystallization behaviour of the Glass 2 is analyzed by X-ray diffraction analysis (XRD) by recording a temperature resolved XRD spectrum from 30° C. up to 900° C. XRD spectra in a 2 theta range from 10 to 60° are taken in air with an interval of 5° C. and a heating rate of 60° C./min between the measurements. FIG. 4 shows a temperature resolved XRD spectrum of Glass 2 and reveals the formation of Ca₂ZnSi₂O₇ (hardystonite), CaZnSi₂O₆, ZnO and Ca₂B₂O₅ crystals at different temperatures. The crystalline areas have an average diameter of crystalline domains of 500-800 nm. The average diameter is visually detected by measuring the average diameter of crystalline domains.

### 3. Production of SOFC/SOEC Cell Sealed with Glass Composition

A SOFC/SOEC cell is produced according to a method described in A. Hagen et. al, J. Electrochem. Soc, 153, A1165 (2006), which is incorporated herewith by reference. Glass 1 is employed as a sealing material. The SOFC/SOEC cell is sealed by the glass composition in accordance with the method described as “cell assembly 1” in S. D. Ebbesen et. Al, Poisoning of Sold Oxide Electrlysis Cells by impurities, Journal of The Electrochemical Society, 157 (10), B1419-B1429 (2010), which is incorporated herewith by reference.

### 4. Characterization of Sealed SOFC/SOEC Cell

A cell test is conducted with the sealed SOFC/SOEC cell. The temperature of cell test is increased from 750° C. after 100 h of testing to 850° C., the steam content in the gas supplied to the Ni-YSZ electrode is increased from 4% (4:96 (H₂O:H₂)) up to 50% (50:50 (H₂O:H₂)) after 200 h hours of testing. A gas flow of 140 l/h of air is applied on the LSM-YSZ electrode during testing, the flow rate on the Ni-YSZ electrode is 24 l/h. The test conditions concerning operation temperature, gas composition and flow rates of the first 100 h correspond to typical SOFC operation conditions, the test conditions after 200 h of testing correspond to typical SOEC operation conditions.

FIG. 5 shows the results of the cell test revealing no leakage (i.e. no drop in the Voltage at OCV) for over 400 h.

FIG. 6 summarizes EDX micrographs of the sealing area after the cell test. The sample for SEM/EDX analysis is prepared in the following manner: The sample including the glass sealing is vacuum embedded in Struers epoxy resin (epofix), ground using SiC paper, polished using 6.3 μm and 1 μm diamond paste, which then is carbon coated to eliminate surface charging. Images are taken on a Zeiss Supra 35 scanning electron microscope equipped with a field emission gun and an EDS detector in backscattered mode with an acceleration voltage of 15 kV. FIG. 6 illustrates that the sealing is still intact. The formation of a Zn enriched phase is found. No diffusion of Cr from the steel into the glass is found. Furthermore, the adhesion after testing at the interfaces is still sufficient.

1. A glass composition for the use as a sealant, comprising
45-55 mol % CaO,
17.5-25 mol % ZnO,
17.5-25 mol % B₂O₃,
7.5-15 mol % SiO₂,
1 mol % or less of each element of the group, comprising Ba, Na and Sr, based on the total glass composition.

2. The glass composition according to claim 1, comprising 35-55 mol % CaO.

3. The glass composition according to claim 1, further comprising 5 mol % or less, MnO.

4. The glass composition according to claim 1, further comprising one or more compounds of the group, comprising La₂O₃, Y₂O₃, PbO, Cr₂O₃, V₂O₅, NiO, CuO, Ti0₂, ZrO₂, As₂O₃, Sb₂O₃, Al₂O₃, Na₂O, K₂O, Fe₂O₃, SrO, BaO and MgO.

5. The glass composition according to claim 1, wherein the sum of CaO, ZnO and B₂O₃ is 60 mol % or more.

6. The glass composition according to claim 1, having a thermal coefficient of expansion (TCF) of 6 to 16×10⁻⁶/° C., as determined by dilatometry measurement.

7. The glass composition according to claim 1, having a melting point Tₘ of 1200° C. or less, as measured by differential scanning calorimeter (DSC).

8. The glass composition according to claim 1, comprising a crystalline microstructure wherein the average diameter of crystalline domains is 1000 nm or less, as measured by scanning electron microscopy (SEM).

9. The glass composition according to claim 1, consisting of
35-70 mol % CaO,
5-45 mol % ZnO,
1-45 mol % SiO₂,
1 mol % or less of each element of the group, comprising Ba, Na and Sr, based on the total glass composition.

10. A solid oxide fuel cell (SOFC), comprising an anode layer and a cathode layer and an ion conducting electrolyte interposed between these layers, wherein the SOFC is sealed by a sealant comprising a glass composition, said glass composition comprising
5-70 mol % CaO,
5-45 mol % ZnO,
5-50 mol % B₂O₃
1-45 mol % SiO₂
1 mol % or less of each element of the group, comprising Ba, Na and Sr, based on the total glass composition.

11. A solid oxide electrolyzer cell (SOEC), comprising an anode layer and a cathode layer and an ion conducting electrolyte interposed between these layers, wherein the SOEC is sealed by a sealant comprising a glass composition, said glass composition comprising
5-70 mol % CaO,
5-45 mol % ZnO,
5-50 mol % B₂O₃
1-45 mol % SiO₂,
1 mol % or less of each element of the group, comprising Ba, Na and Sr, based on the total glass composition.

12. A method of sealing parts of a device with a glass composition, said glass composition comprising:
5-70 mol % CaO,
5-45 mol % ZnO,
5-50 mol % B₂O₃
1-45 mol % SiO₂,
1 mol % or less of each element of the group, comprising Ba, Na and Sr, based on the total glass composition as a sealant for sealing various parts of a device selected from the group, comprising a SOFC, a SOEC, an oxygen membrane or a sensor.
